(19) United States
(12) Patent Application Publication
(10) Pub. No.: US 2014/0286221 A1
(43) Pub. Date: Sep. 25, 2014

(54) ACTIVATION OF MULTICAST SERVICE

(71) Applicant: NOKIA SIEMENS NETWORKS OY, Espoo (FI)

(72) Inventors: Devaki CHANDRAMOULI, Plano, TX (US); Rainer LIEBHART, Munich (DE)

(73) Assignee: NOKIA SIEMENS NETWORKS OY, Espoo (FI)

(21) Appl. No.: 13/847,678

(22) Filed: Mar. 20, 2013

(51) Int. Cl. H04L 12/18

(52) U.S. Cl. CPC H04L 12/189
USPC 370/312

(57) ABSTRACT

Activation of multicast service may benefit various communication systems. For example, communication systems of the evolved packet system may benefit from the use of properly established bearers. A method may include establishing, by a device, a bearer with a gateway. The method may also include initiating a request for multicast services, using the bearer to initiate the request for multicast services. The gateway may be a packet data network gateway or a multimedia broadcast multicast services gateway, and the device may be a user equipment.

### BACKGROUND

1. Field

Activation of multicast service may benefit various communication systems. For example, communication systems of the evolved packet system may benefit from the use of properly established bearers.

2. Description of the Related Art

Evolved Packet System (EPS) is a successor of General Packet Radio System (GPRS), which provides a new radio interface and new packet core network functions for broadband wireless data access. Such EPS core network functions can include the Mobility Management Entity (MME), Packet Data Network Gateway (PDN-GW, P-GW, PGW) and Serving Gateway (S-GW).

A common packet domain Core Network is used for the Radio Access Networks (RAN) GERAN, E-UTRAN and UTRAN. 3GPP specified an architecture for Multimedia Broadcast/Multicast Service (MBMS). Currently the architecture supports broadcast services only. There is no known solution for activation of multicast services in EPS.

Instead, third generation partnership project (3GPP) currently supports only broadcast services for EPS. Multicast is not supported at this time for EPS. Broadcast service may not fulfill all the use cases and requirements of operators, as broadcast will involve streaming data to all user equipment (UEs) in a certain cell. Broadcast delivery may also be suboptimal from the standpoint of radio and core network resources. For example, using broadcasting just to enable group communication amongst 10 police officers who are part of a group in a certain cell may use a large amount of resources relative to the benefit of group communication.

FIG. 1 illustrates a reference architecture for Evolved Packet System with Universal Terrestrial Radio Access Network (UTRAN) and evolved UTRAN (E-UTRAN), MBMS Broadcast Mode only. As shown in FIG. 1, UEs 110 and 115 can be connected to E-UTRAN 120 and UTRAN 125 over interfaces E-UTRAN Uu or Uu, respectively.

E-UTRAN 120 can be connected to MME 130 over interface M3 and can be connected to MBMS gateway (MBMS GW) 135 over interface M1. The mobility management entity (MME) 130 can be connected to the MBMS GW 135 over interface Sm.

UTRAN 125 can be connected to serving GPRS support node (SGSN) 132 over interface Iu. In turn, the SGSN 132 can be connected to MBMS GW 135 over interface Sn.

The MBMS GW 135 can be connected to BM-SC 140 over interfaces SGmb and SGi-mb. The BM-SC 140 can be connected to PDN Gateway 150 over interface SGi. Likewise, the broadcast-multicast service center (BM-SC) 140 can be connected to the content provider 160 over any suitable interface.

### SUMMARY

According to a first embodiment, a method includes establishing, by a device, a bearer with a gateway. The method also includes initiating a request for multicast services, using the bearer to initiate the request for multicast services.

According to a second embodiment, a method includes creating, by a gateway, a bearer for a device. The method also includes fulfilling a request, sent on the bearer, for multicast services.

According to a third embodiment, an apparatus includes at least one processor and at least one memory including computer program code. The at least one memory and the computer program code are configured to, with the at least one processor, cause the apparatus at least to establish, by a device, a bearer with a gateway. The at least one memory and the computer program code are also configured to, with the at least one processor, cause the apparatus at least to initiate a request for multicast services, using the bearer to initiate the request for multicast services.

According to a fourth embodiment, an apparatus includes at least one processor and at least one memory including computer program code. The at least one memory and the computer program code are configured to, with the at least one processor, cause the apparatus at least to create, by a gateway, a bearer for a device. The at least one memory and the computer program code are also configured to, with the at least one processor, cause the apparatus at least to fulfill a request, sent on the bearer, for multicast services.

According to a fifth embodiment, an apparatus includes establishing means for establishing, by a device, a bearer with a gateway. The apparatus also includes initiating means for initiating a request for multicast services, using the bearer to initiate the request for multicast services.

According to a sixth embodiment, an apparatus includes creating means for creating, by a gateway, a bearer for a device. The apparatus also includes fulfilling means for fulfilling a request, sent on the bearer, for multicast services.

According to seventh and eighth embodiments, an apparatus includes a non-transitory computer-readable medium encoded with instructions that, when executed in hardware, perform a process. The process comprises respectively the methods of the first or second embodiments.

According to a ninth embodiment, a system includes a first apparatus and a second apparatus. The first apparatus includes establishing means for establishing, by a device, a bearer with a gateway. The first apparatus also includes initiating means for initiating a request for multicast services, using the bearer to initiate the request for multicast services. The second apparatus includes creating means for creating, by the gateway, the bearer for the device. The second apparatus also includes fulfilling means for fulfilling the request, sent on the bearer, for multicast services.

### BRIEF DESCRIPTION OF THE DRAWINGS

For proper understanding of the invention, reference should be made to the accompanying drawings, wherein:

FIG. 1 illustrates a reference architecture for Evolved Packet System.

FIG. 2 illustrates a signal flow diagram of a first method according to certain embodiments.

FIG. 3 illustrates a signal flow diagram of a second method according to certain embodiments.

FIG. 4 illustrates methods according to certain embodiments.

FIG. 5 illustrates a system according to certain embodiments of the invention.

### DETAILED DESCRIPTION

Multimedia broadcast/multicast service (MBMS) may be useful for supporting the exponential growth of data traffic caused by mobile phones including smart phones, other mobile devices such as tablets, dongles and machine type devices. Group communication can also be useful in the context of public safety and in the context of railway systems, such as global system for mobile communications (GSM)-Railway (GSM-R). Long term evolution (LTE)-Railway (LTE-R) may similarly employ a technology for voice group call service (VGCS)/voice broadcast service (VBS).

Operators can also deploy MBMS for regularly provided services such as video download, software upgrade notification, software download, and triggering devices in a group.

Multicast service activation can be used to support group communication for public safety market, LTE-R market and for other streaming services. In case of other types of services that involve subscription/join and leave procedures, such as pay per movie channels, or certain television (TV) providers, operators may also benefit from MBMS multicast.

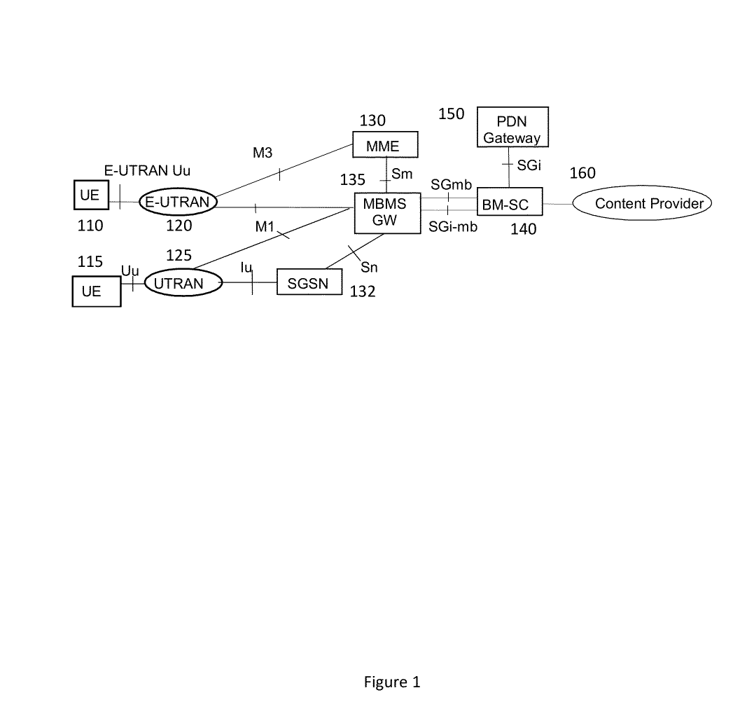

Certain embodiments provide at least two options for activating and maintaining multicast services in, for example, EPS. In the architecture illustrated in FIG. 1, MBMS-GW 135 and P-GW 150 are considered as two independent network functions. Thus, certain embodiments can provide at least two independent approaches.

According to a first embodiment, a user equipment (UE) can use a default bearer established with a P-GW. Moreover, the UE can use the default bearer to initiate the request for multicast services.

According to a second embodiment, a UE can establish a bearer directly with an MBMS-GW. Moreover, the UE can use the bearer to initiate the request for multicast services.

The MBMS-GW and P-GW may be collocated in practice and both embodiments may be applicable when MBMS-GW and P-GW are collocated.

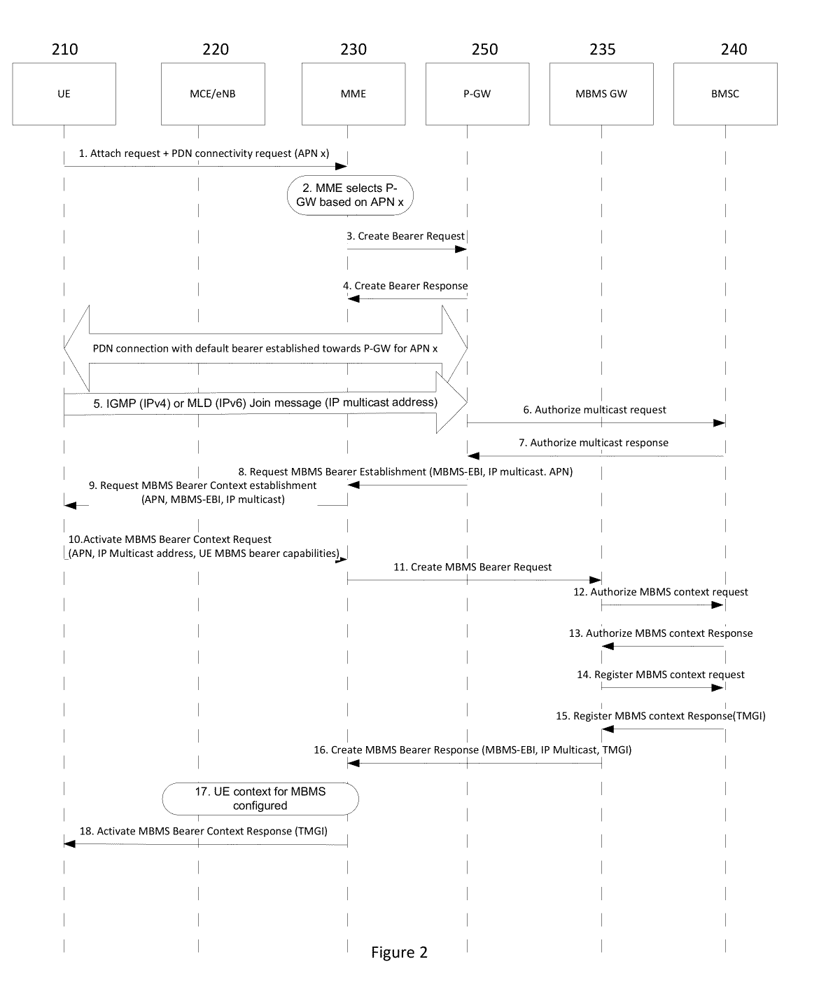

FIG. 2 illustrates a signal flow diagram of a first method according to certain embodiments. As shown in FIG. 2, UE 210 can use a default bearer established with P-GW 250 to initiate the request for multicast services.

At 1-4, UE 210 can initiate attach procedure and establishes PDN connection with access point name (APN) x based on procedures defined in TS 23.401. APN x can be a default APN or a special APN used for multicast/broadcast services. This can include, at 1, UE 210 sending an attach request and PDN connectivity request for APN x. This can also include, at 2, the MME 230 selecting a P-GW, namely P-GW 250, based on APN x. At 3, the MME 230 can send a create bearer request to P-GW 250. Then, at 4, the P-GW 250 can send a create bearer response to MME 230.

At 5, UE 210 can register to obtain multicast services at the application layer and can receive an internet protocol (IP) multicast address for the corresponding multicast service. Alternatively, IP multicast address can be stored in UE's subscription data in home subscriber server (HSS) or in MME or PGW per special multicast APN and provided to the UE in the non-access stratum (NAS) signaling. UE 210 can send an internet group management protocol (IGMP) (IPv4) or multicast listener discovery (MLD) (IPv6) Join message over the default bearer to signal UE 210's interest in receiving a particular multicast MBMS bearer service identified by an IP multicast address.

At 6, P-GW 250 can send an Authorization Request seeking authorization for the activating UE 210 to receive multicast data. The authorization decision may be based on subscription data in the BM-SC 240.

At 7, BM-SC 240 can authorize and respond with MBMS authorization response. If the MBMS Authorization Response indicates that UE 210 is not authorized to receive the MBMS data, the process can terminate at this step. Membership function can be provided in the MBMS Authorization Response together with the APN to be used for creation of the MBMS UE 210 context.

At 8, if the authorization was successful, P-GW 250 can provide the IP multicast address and MBMS EPS bearer ID (MBMS-EBI) for the corresponding multicast service in the request MBMS context establishment message to the MME 230. P-GW 250 can also include the APN provided by the BMSC 240.

At 9, MME 230 can provide the MBMS APN, MBMS-EBI and IP multicast address to UE 210 in Request MBMS context establishment message.

At 10, UE 210 can initiate the establishment of MBMS context for multicast service. Multicast services can include, for example, subscription and membership. UE 210 can send an initiate activation of MBMS context request. The request can include the APN, UE 210 MBMS bearer capabilities and IP Multicast address.

At 11, MME 230 can include UE 210 MBMS bearer capabilities in a Create Bearer Response message to the MBMS GW 235.

At 12, MBMS GW 235 can establish an MBMS context for UE 210 and can determine whether the MBMS bearer context capabilities are sufficient for the corresponding multicast service. If not, the establishment procedure can stop here and MBMS GW 235 can respond to the MME 230 with a reject message. If the MBMS bearer context capabilities are sufficient, MBMS GW 235 can proceed with the establishment of the MBMS bearer service. MBMS GW 235 can send an authorization request for activating multicast service for UE 210. It may provide the IMSI, MSISDN, TAI, SAI, RAT type. This step may be optional if, for example, the authorization obtained at 7 is valid.

At 13, BM-SC 240 can respond with the authorization response and can create an MBMS UE 210 context.

At 14, if MBMS bearer context is not available for the corresponding multicast service, MBMS GW 235 can register the multicast service with the BM-SC 240 to register the service and obtain TMGI.

At 15, if no TMGI has been allocated for this MBMS bearer service, the BM-SC 240 can allocate a new TMGI. BM-SC 240 can respond with a Register MBMS Context Response message and can include the TMGI.

At 16, the allocated TMGI can be passed to MME 230 in the Create MBMS Bearer Response message.

At 17, MME 230 can configure the UE 210 MBMS context with the radio network (MCE/eNB).

At 18, MME 230 can complete the activation of MBMS bearer service and can send Activate MBMS Bearer Context Response message along with the temporary mobile group identity (TMGI) to UE 210.

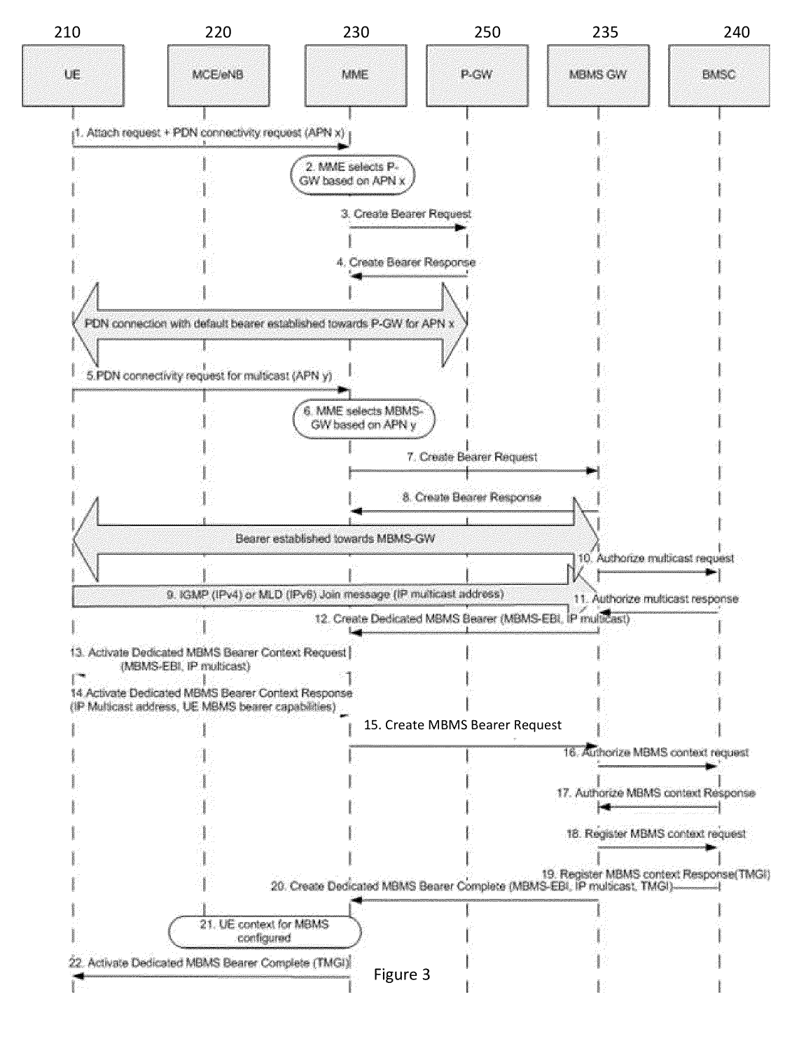

FIG. 3 illustrates a signal flow diagram of a second method according to certain embodiments. As shown in FIG. 3, UE 210 can establish a bearer directly with the MBMS-GW 235 and can use the bearer to initiate the request for multicast services.

At 1-4 UE 210 can initiate an attach procedure and establish a PDN connection with APN x based on procedures defined in 3GPP Technical Specification (TS) 23.401, which is hereby incorporated herein by reference in its entirety. This procedure can be similar to the steps 1-4 shown in FIG. 2.

At 5, UE 210 can send a standalone PDN connectivity request with APN y, used for MBMS services.

At 6, MME 230 can select MBMS GW 235 based on APN y. MME 230 can select the corresponding MBMS GW 235 for bearer establishment.

At 7, MME 230 can establish a bearer towards the MBMS GW 235.

At 8, MBMS GW 235 can establish the bearer and can respond to the MME 230 with a Create Bearer Response message.

At 9, UE 210 can register to obtain multicast services at the application layer and can receive IP multicast address for the corresponding multicast service. Multicast services can include, for example, subscription and membership. UE 210 can send an IGMP (IPv4) or MLD (IPv6) Join message over the default bearer to signal UE 210's interest in receiving a particular multicast MBMS bearer service identified by an IP multicast address. IP multicast address can be received by the UE via application layer signaling or via NAS signaling if it is stored in the HSS per UE, or in MME or PGW per special multicast APN and provided to the UE.

At 10, MBMS GW 235 can send an Authorization Request seeking authorization for the activating UE 210 to receive multicast data. The authorization decision may be based on subscription data in the BM-SC 240. Membership function can be provided in the MBMS Authorization Response message together with the APN, to be used for creation of the MBMS UE 210 context.

At 11, BM-SC 240 can authorize and respond with an MBMS authorization response. If the MBMS Authorization Response indicates that UE 210 is not authorized to receive the MBMS data, the process can terminate at this step. MBMS GW 235 can initiate deactivation of default bearer and the PDN connection.

At 12, if the authorization was successful, MBMS GW 235 can initiate dedicated bearer establishment. MBMS GW 235 can provide the IP multicast address and MBMS-EBI for the corresponding multicast service to the MME 230.

At 13, MME 230 can forward the MBMS-EBI and IP multicast address to UE 210 in an Activate Dedicated MBMS Context Request procedure.

At 14, UE 210 can establish a context for the MBMS multicast service and can respond with an Activate Dedicated MBMS Bearer Context Response. UE 210 can also include UE 210's MBMS bearer capabilities.

At 15, MME 230 can include UE 210's MBMS bearer capabilities in the Create MBMS Bearer Request message to the MBMS GW 235.

At 16, MBMS GW 235 can determine whether the MBMS bearer context capabilities are sufficient for the corresponding multicast service. If not, the establishment procedure can stop here and MBMS GW 235 can respond to the MME 230 with a reject message. If the MBMS bearer context capabilities are sufficient, MBMS GW 235 can proceed with the establishment of the MBMS bearer service. MBMS GW 235 can send an authorization request for activating multicast service for UE 210. The request may provide the IMSI, MSISDN, TAI, SAI, RAT type. This step may be optional, for example, when the authorization obtained at 11 is valid.

At 17, BM-SC 240 can respond with an authorization response and can create an MBMS UE 210 context.

At 18, if MBMS bearer context is not available for the corresponding multicast service, MBMS GW 235 can register the multicast service with the BMSC 240 to register the service and obtain the TMGI.

At 19, if no TMGI has been allocated for this MBMS bearer service, the BM-SC 240 can allocate a new TMGI and respond with Register MBMS Context Response.

At 20, the TMGI can be passed to MME 230 in a Create MBMS Dedicated Bearer Complete message.

At 21, MME 230 can configure the UE 210 MBMS context with the radio network (MCE/eNB).

At 22, MME 230 can complete the activation of MBMS bearer service and can send Activate Dedicated MBMS Bearer Complete message along with the TMGI.

Advantages of certain embodiments can include providing solutions for missing functionality for MBMS multicast in 3GPP as well as maximum re-use of existing EPS bearer handling procedures. Thus, certain embodiments enable easier adoption of these procedures if or when multicast services for LTE becomes a necessity. Certain embodiments may fulfill the bearer establishment procedure requirements for multicast service activation. Moreover, certain embodiments may be beneficial to enable group communication for a public safety market, for an LTE-R market when it is in use, for M2M, and for general group based services provided to mobile devices.

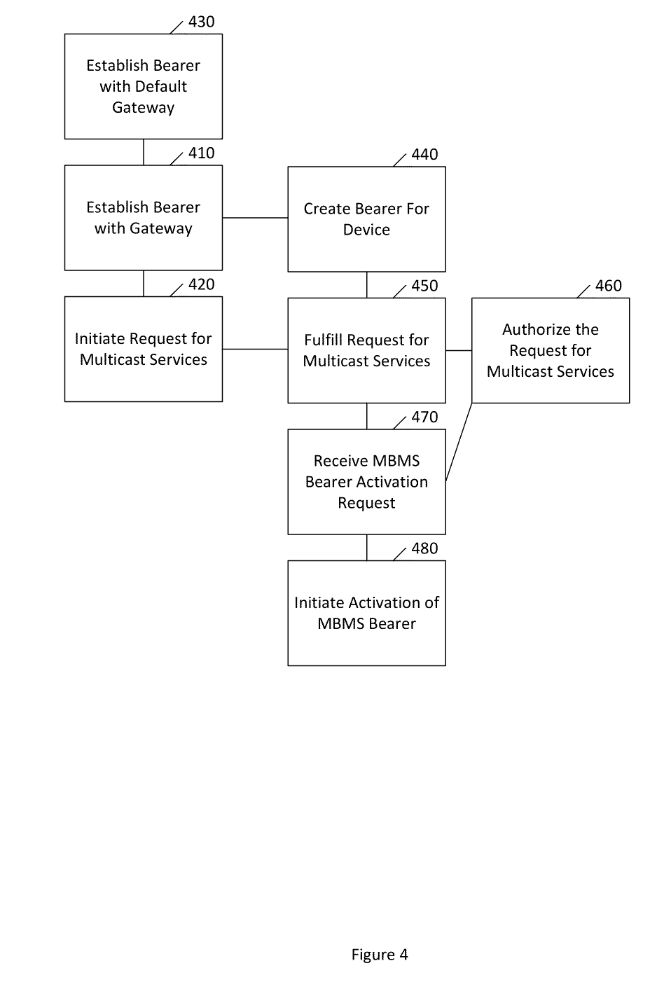

FIG. 4 illustrates methods according to certain embodiments. As shown in FIG. 4, a method may include, at 410, establishing, by a device, a bearer with a gateway. The method may also include, at 420, initiating a request for multicast services, using the bearer to initiate the request for multicast services. The initiating the request can include providing a join message to the gateway.

The device can be a user equipment and the gateway can be a packet data network gateway or a multimedia broadcast multicast services gateway, either one or both such gateways.

The method may further include, at 430, establishing by the device, a default bearer with a packet data network gateway prior to establishing the bearer with the gateway.

The method can also include, at 440, creating, by a gateway, a bearer for a device. The method can further include, at 450, fulfilling a request, sent on the bearer, for multicast services.

The method can additionally include at 460, authorizing the request for multicast service by contacting a broadcast-multicast service center. Authorizing here can refer, for example, to authenticating that the request is valid.

The method can also include, at 470, receiving a multimedia broadcast multicast services bearer activation request. The method can further include, at 480, initiating activation of a multimedia broadcast multicast services bearer after processing the multimedia broadcast multicast services bearer activation request. The initiating can include sending a create MBMS bearer response to an MME. The MME can then configure a UE context for MBMS with an MCE/eNB and activate the MBMS bearer context with an activate MBMS bearer context response.

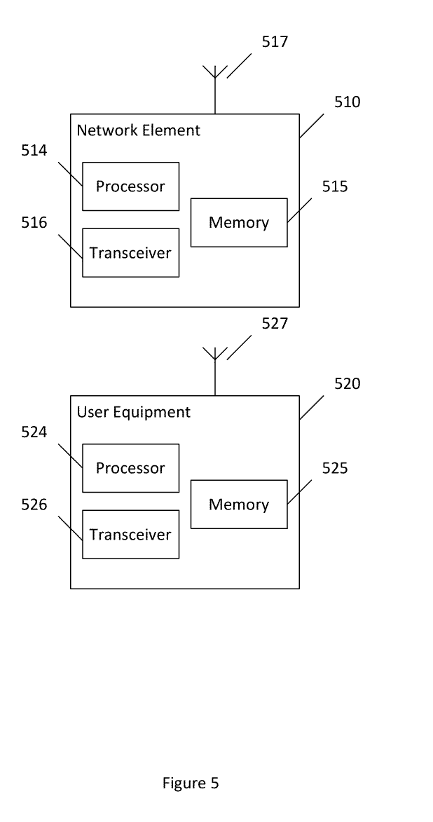

FIG. 5 illustrates a system according to certain embodiments of the invention. In one embodiment, a system may comprise several devices, such as, for example, network element 510 and UE 520. The system may comprise more than one UE 520 and more than one network element 510, although only one of each is shown for the purposes of illustration. A network element can be an access point, a base station, an eNode B (eNB), an MCE, an MME, a gateway, a P-GW, an MBMS GW, a BMSC, or any of the other network elements discussed herein, such as those shown in FIGS. 1-3. Each of these devices may comprise at least one processor, respectively indicated as 514 and 524. At least one memory may be provided in each device, and indicated as 515 and 525, respectively. The memory may comprise computer program instructions or computer code contained therein. One or more transceiver 516 and 526 may be provided, and each device may also comprise an antenna, respectively illustrated as 517 and 527. Although only one antenna each is shown, many antennas and multiple antenna elements may be provided to each of the devices. Other configurations of these devices, for example, may be provided. For example, network element 510 and UE 520 may be additionally configured for wired communication, in addition to wireless communication, and in such a case antennas 517 and 527 may illustrate any form of communication hardware, without being limited to merely an antenna. Likewise, some network elements 510 may be solely configured for wired communication, and such cases antenna 517 may illustrate any form of wired communication hardware, such as a network interface card.

Transceivers 516 and 526 may each, independently, be a transmitter, a receiver, or both a transmitter and a receiver, or a unit or device that may be configured both for transmission and reception.

Processors 514 and 524 may be embodied by any computational or data processing device, such as a central processing unit (CPU), application specific integrated circuit (ASIC), or comparable device. The processors may be implemented as a single controller, or a plurality of controllers or processors.

Memories 515 and 525 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language.

The memory and the computer program instructions may be configured, with the processor for the particular device, to cause a hardware apparatus such as network element 510 and UE 520, to perform any of the processes described above (see, for example, FIG. 2-4). Therefore, in certain embodiments, a non-transitory computer-readable medium may be encoded with computer instructions that, when executed in hardware, may perform a process such as one of the processes described herein. Alternatively, certain embodiments of the invention may be performed entirely in hardware.

Furthermore, although FIG. 5 illustrates a system including a network element 510 and a UE 520, embodiments of the invention may be applicable to other configurations, and configurations involving additional elements, as illustrated and discussed herein. For example, multiple user equipment devices and multiple network elements may be present (see, for example, FIGS. 1-3), or other nodes providing similar functionality, such as nodes that combine the functionality of multiple of the devices shown in FIGS. 1-3, for example a network element that combines a P-GW and an MBMS GW.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

### GLOSSARY

MBMS Multimedia Broadcast/Multicast Service

MBMS GW MBMS Gateway

MBMS SAI MBMS Service Area Identity

MBMS-EBI MBMS EPS bearer ID

MCE Multi-cell/multicast Coordination Entity

BMSC, BM-SC Broadcast-Multicast Service Center

TMGI Temporary Mobile Group Identity

TAI Tracking Area Identity

SAI Service Area Identity

RAI Routing Area Identity

RAT Radio Access Technology

UE User Equipment

APN Access Point Name

EPS Evolved Packet System

GPRS General Packet Radio System

SGSN Serving GPRS Support Node

MME Mobility Management Entity

PDN-GW, P-GW Packet Data Network Gateway

S-GW Serving Gateway

UTRAN Universal Terrestrial Radio Access Network

VGCS Voice Group Call Services

VBS Voice Broadcast Service

GSM Global System for Mobile Communication

GSM-R GSM-Railway

3GPP Third Generation Partnership Project

LTE Long Term Evolution of 3GPP

LTE-R LTE-Railway

TS Technical Specification

IP Internet Protocol

IGMP Internet Group Management Protocol

MLD Multicast Listener Discovery

We claim:

1. A method, comprising:
establishing, by a device, a bearer with a gateway; and
initiating a request for multicast services, using the bearer to initiate the request for multicast services.

2. The method of claim 1, wherein the device comprises a user equipment.

3. The method of claim 1, wherein the gateway comprises a packet data network gateway or a multimedia broadcast multicast services gateway.

4. The method of claim 1, further comprising:
establishing by the device, a default bearer with a packet data network gateway prior to establishing the bearer with the multimedia broadcast multicast services gateway and the device receiving an internet protocol multicast address via application layer signaling or via non-access stratum signaling from a mobility management entity when the internet protocol multicast address is stored in a home subscriber server, the mobility management entity or packet data network gateway.

5. The method of claim 1, further comprising:
establishing by the device, a default bearer with a multimedia broadcast multicast services gateway prior to establishing the multicast bearer with the multimedia broadcast multicast services gateway and the device receiving an internet protocol multicast address via application layer signaling or via non-access stratum signaling from a mobility management entity when the internet protocol multicast address is stored in a home subscriber server, the mobility management entity or a packet data network gateway.

6. The method of claim 1, wherein the initiating the request comprises providing a join message to the gateway.

7. A method, comprising:
creating, by a gateway, a bearer for a device; and
fulfilling a request, sent on the bearer, for multicast services.

8. The method of claim 7, wherein the device comprises a user equipment.

9. The method of claim 7, wherein the gateway comprises a packet data network gateway or a multimedia broadcast multicast services gateway.

10. The method of claim 7, further comprising:
authorizing the request for multicast service by contacting a broadcast-multicast service center.

11. The method of claim 7, further comprising:
receiving a multimedia broadcast multicast services bearer activation request;
initiating activation of a multimedia broadcast multicast services bearer after processing the multimedia broadcast multicast services bearer activation request; and
providing an internet protocol multicast address by a mobility management entity or a packet data network gateway to the device.

12. An apparatus, comprising:
at least one processor; and
at least one memory including computer program code,
wherein the at least one memory and the computer program code are configured to, with the at least one processor, cause the apparatus at least to
establish, by a device, a bearer with a gateway; and
initiate a request for multicast services, using the bearer to initiate the request for multicast services.

13. The apparatus of claim 12, wherein the device comprises a user equipment.

14. The apparatus of claim 12, wherein the gateway comprises a packet data network gateway or a multimedia broadcast multicast services gateway.

15. The apparatus of claim 12, wherein the at least one memory and the computer program code are configured to, with the at least one processor, cause the apparatus at least to establish by the device, a default bearer with a packet data network gateway prior to establishing the bearer with the multimedia broadcast multicast services gateway and the device receiving an internet protocol multicast address via application layer signaling or via a mobility management entity when the internet protocol multicast address is stored in a home subscriber server.

16. The apparatus of claim 12, wherein the at least one memory and the computer program code are configured to, with the at least one processor, cause the apparatus at least to establish by the device, a default bearer with a multimedia broadcast multicast services gateway prior to establishing the multicast bearer with multimedia broadcast multicast services gateway and the device receiving an internet protocol multicast address via application layer signaling or via non-access stratum signaling from a mobility management entity when the internet protocol multicast address is stored in a home subscriber server, the mobility management entity or a packet data network gateway.

17. The apparatus of claim 12, wherein the at least one memory and the computer program code are configured to, with the at least one processor, cause the apparatus at least to initiate the request by providing a join message to the gateway.

18. An apparatus, comprising:
at least one processor; and
at least one memory including computer program code,
wherein the at least one memory and the computer program code are configured to, with the at least one processor, cause the apparatus at least to
create, by a gateway, a bearer for a device; and
fulfill a request, sent on the bearer, for multicast services.

19. The apparatus of claim 18, wherein the device comprises a user equipment.

19. The apparatus of claim 18, wherein the gateway comprises a packet data network gateway or a multimedia broadcast multicast services gateway.

20. The apparatus of claim 18, wherein the at least one memory and the computer program code are configured to, with the at least one processor, cause the apparatus at least to authorize the request for multicast service by contacting a broadcast-multicast service center.

21. The apparatus of claim 18, wherein the at least one memory and the computer program code are configured to, with the at least one processor, cause the apparatus at least to
receive a multimedia broadcast multicast services bearer activation request;
initiate activation of a multimedia broadcast multicast services bearer after processing the multimedia broadcast multicast services bearer activation request; and
providing an internet protocol multicast address by a mobility management entity or a packet data network gateway to the device.
